(19) United States
(12) Patent Application Publication
(10) Pub. No.: US 2023/0342379 A1
(43) Pub. Date: Oct. 26, 2023

(54) PARTITIONING TIME SERIES DATA USING CATEGORY CARDINALITY

(71) Applicant: Microsoft Technology Licensing, LLC, Redmond, WA (US)

(72) Inventors: Nazmiye Ceren ABAY, Kirkland, WA (US); Nikolay Sergeyevich ROVINSKIY, Redmond, WA (US); Vladimir BEJAN, Redmond, WA (US); Eric T. WRIGHT, Redmond, WA (US); Jia LIU, Clyde Hill, WA (US); Neil Arturo TENENHOLTZ, Cambridge, MA (US); Vijaykumar K. ASKI, Bellevue, WA (US); Daniel Harrison HOLSTEIN, Union City, CA (US)

(21) Appl. No.: 17/727,647

(22) Filed: Apr. 22, 2022

(51) Int. Cl. G06F 16/28; G06F 16/2455

(52) U.S. Cl. CPC G06F 16/285; G06F 16/24556

(57) ABSTRACT

The disclosure herein describes using probabilistic cardinality generation to partition time series data into subsets without entries that have duplicate time index values. Time series data including a plurality of categories and a time index category is obtained. Cardinality estimate values of the categories are generated using a probabilistic cardinality estimator and a candidate category is selected based on the cardinality estimate value of the selected candidate category. A time series identifier is generated using the candidate category and, based on the cardinality estimate value of the time series identifier indicating that subsets of the time series data partitioned based on the time series identifier lack entries with duplicate time index values, the time series data is partitioned into a set of time series grain data sets. The time series grain data sets can be used to train models using machine learning techniques.

### BACKGROUND

Machine learning techniques and methods enable data scientists to build models that perform classification, regression, forecasting, and other tasks. Such models are used in a broad range of industries such as retail, supply chain, energy, and finance. Model training platforms allow users to provide sets of training data and to instruct the model training platform to train models based on the provided data. However, because the model training process is complex, errors introduced by the users in the provided training data can cause the training process to fail or otherwise prevent the model training platform from completing the training process. For instance, in some examples, users provide information that indicates how provided training data should be partitioned into separate training data sets, but if this information is incorrect or not provided, the model training process is inhibited by the presence of duplicate time index values in the training data set.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for partitioning time series data into subsets without entries that have duplicate time index values is described. Time series data including a plurality of categories and a time index category is obtained. Cardinality estimate values of the categories are generated using a probabilistic cardinality estimator and a candidate category is selected based on the cardinality estimate value of the selected candidate category exceeding the cardinality estimate values of the other categories. A time series identifier is generated using the candidate category and, based on the cardinality estimate value of the time series identifier indicating that subsets of the time series data partitioned based on the time series identifier lack entries with duplicate time index values, the time series data is partitioned into a set of time series grain data sets.

### BRIEF DESCRIPTION OF THE DRAWINGS

The present description will be better understood from the following detailed description read in light of the accompanying drawings, wherein:

FIG. 1 is a block diagram illustrating a system configured to generate time series grain data sets from a single time series data set with duplicate time index values;

FIG. 2 is a block diagram illustrating a system configured to train a machine learning model based on time series grain data sets generated from a time series grain generator of FIG. 1;

FIGS. 3A-3D are diagrams illustrating a time series data set and selecting candidate categories of the data set based on the cardinality thereof;

FIG. 4 is a flowchart illustrating a method for partitioning time series data into a set of time series grain data sets that lack entries with duplicate time index values;

FIG. 5 is a flowchart illustrating a method for partitioning time series data into a set of time series grain data sets based on a time series identifier derived from candidate categories;

FIG. 6 illustrates an example computing apparatus as a functional block diagram;

FIG. 7 is a flowchart illustrating operation of an example implementation of an automatic time series identifier detection system; and

FIG. 8 is a diagram illustrating an example implementation of parallel cardinality processing.

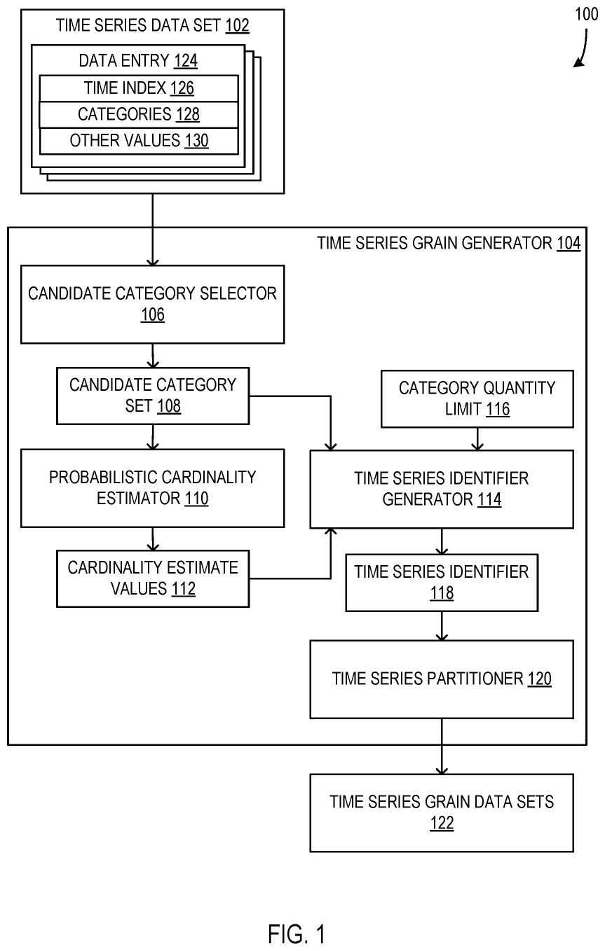

Corresponding reference characters indicate corresponding parts throughout the drawings. In FIGS. 1 to 8, the systems are illustrated as schematic drawings. The drawings may not be to scale.

### DETAILED DESCRIPTION

Aspects of the disclosure provide a computerized method and system for partitioning a time series data set, that contains duplicate time index values, into subsets that do not include duplicate time index values based on cardinality of categories. The process obtains time series data that includes entries with duplicate time index values. The categories of the time series data are analyzed to generate cardinality estimate values for the categories using a probabilistic cardinality estimator. The cardinality estimate values are used to select a category with the highest cardinality estimate value, which is included in a time series identifier, and the time series data is partitioned into a set of time series grain data sets based on that time series identifier. If the entries in each time series grain data set would include duplicate time index values, the process of selecting categories for the time series identifier repeats until the uniqueness constraint is met. In some examples, those time series grain data sets are used to train models using machine learning techniques (e.g., training a model to forecast or predict prices of products based on associated categories).

While some examples are described with reference to probabilistic estimation of cardinality (e.g., for large data sets), the disclosure is not limited to such examples. In other examples, cardinality calculation is performed without probabilistic estimation (e.g., an exact count is obtained).

The disclosure operates in an unconventional manner at least by using a combination of greedy algorithms and probabilistic cardinality estimation algorithms (e.g., a HyperLogLog (HLL) algorithm) to effectively determine a time series identifier of a time series data set in a time-efficient and space-efficient manner. In some examples, unique time series and their optimal identifies are detected in real-time, leveraging probabilistic algorithms and distributed processing to scale to large datasets to reduce runtime. The use of cardinality estimates of categories of the time series data set reduces the space and time complexity of the process of determining cardinality of categories on very large data sets (e.g., “Big Data” sets). The greedy algorithm is used to select the category or categories with maximum cardinality to efficiently eliminate duplicate time index values when the time series data is partitioned based on the selected categories. Some examples use a combination of greedy algorithm and probabilistic distinct counting algorithms, which results in a faster solution compared to a brute force method which iterates over all permutations of possible time series identifiers, such as the exhaustive search next described.

Current approaches to detect the time series identifier categories with exhaustive searches are impractical for use with highly dimensional data because these approaches iterate all possible subsets of categories with a time complexity of O (n*2\hat{ }n)) and space complexity of O(n). Iterating on all possible subsets of categories may not return in a reasonable time due to expensive search operations and, in some such systems, it causes timeout errors and/or memory consumption errors. The disclosure substantially reduces the time complexity to O(n) and space complexity to O(LogLogN) to avoid such errors and enable the process to be completed in a reasonable amount of time. Further, while some examples of the disclosure do not compute exact cardinality values for categories, the exact values are not needed in these examples when the greedy algorithm selects categories for use in the time series identifier as described herein.

The disclosure reduces the quantity of time and processing resources required to evaluate categories of a time series data set at least by generating cardinality estimate values for the categories of the time series data set using a probabilistic cardinality estimator (e.g., using a HyperLogLog algorithm). Further, categories are efficiently selected for use in the time series identifier based on the generated cardinality estimate values of the selected categories exceeding the cardinality estimate values of other potential categories (e.g., the category or categories with the highest cardinality estimate values).

Additionally, the disclosure enables the configuration of candidate category identification rules (e.g., candidate categories must include values for all entries in the data set) which reduce the quantity of categories that must be analyzed, further improving the performance of the described systems and methods.

Further, the disclosure enables batch processing during calculation of separate cardinality estimate values of categories and within the process of generating a cardinality estimate value for a category (e.g., the time series data is divided into a plurality of data subsets, subset cardinality estimate values are generated for each data subset, and the subset cardinality estimate values are combined into the cardinality estimate value). Such batch processing enables the disclosure to operate efficiently with respect to available processing resources and/or other associated resources, including enabling batches to be processed in parallel. For instance, cardinality estimate values of two or more categories are calculated in parallel and/or subset cardinality estimate values for two or more data subsets are calculated during the generation of a single cardinality estimate value.

FIG. 1 is a block diagram illustrating a system 100 configured to generate time series grain data sets 122 from a single time series data set 102 with duplicate time index values 126. The system 100 includes a time series grain generator 104 that is configured to analyze the time series data set 102 and generate a set of categories 128 to be used as a time series identifier 118 for partitioning the time series data set 102 into the multiple time series grain data sets 122.

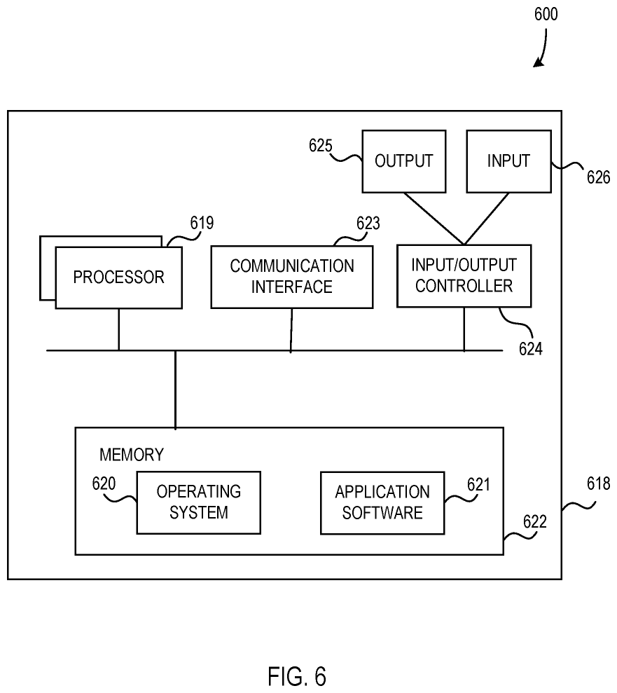

In some examples, the time series grain generator 104 is located and executed on one or more computing devices (e.g., the computing device of FIG. 6). In some examples where the generator 104 is located and/or executed on more than one computing device, the generator 104 is distributed across multiple computing devices that are connected via a network (e.g., a private intranet, the Internet, or the like). Additionally, or alternatively, the time series grain generator 104 is configured to communicate with other applications, computing devices, and/or other entities via network interfaces or other similar communication interfaces.

Further, the time series grain generator 104 is configured to receive or otherwise obtain the time series data set 102 and to process the data set 102 to generate a candidate category set 108 from the categories 128 of the data entries 124 of the set 102. The candidate category selector 106 is configured to analyze the contents of the data entries 124 and select categories from the categories 128 that can be used as part of the time series identifier 118. In some examples, the analysis includes selecting categories for which each data entry 124 has a non-empty value. For instance, in an example where the data set 102 is formatted as a data table, each entry 124 is a row in the data table, and the categories 128 are represented as columns of the data table, the candidate category selector 106 selects categories that are associated with “complete” columns, or columns that do not have any empty values throughout the data table.

Further, in some examples, the candidate category selector 106 is configured to select candidate categories based on one or more other established candidate selection criteria or rules. For instance, in an example, a category 128 is not included in the candidate category set 108 based on the category not satisfying candidate selection criteria.

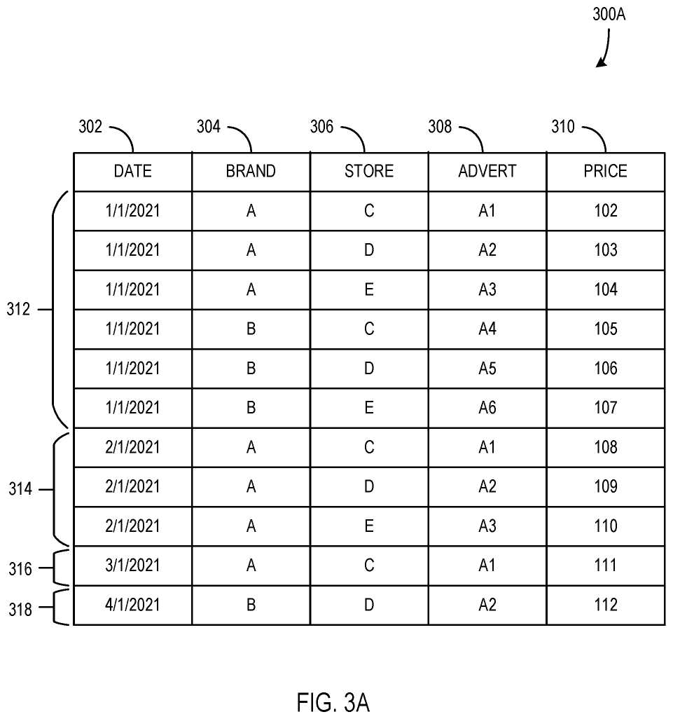

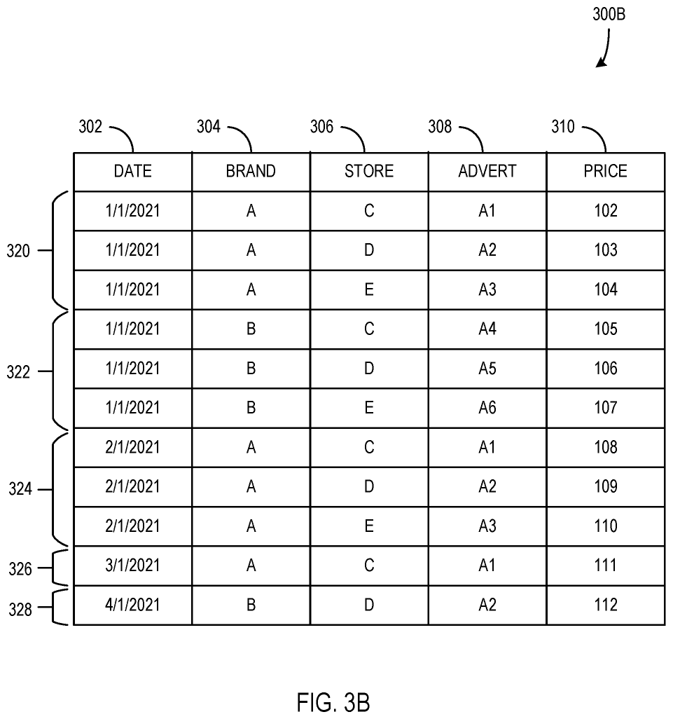

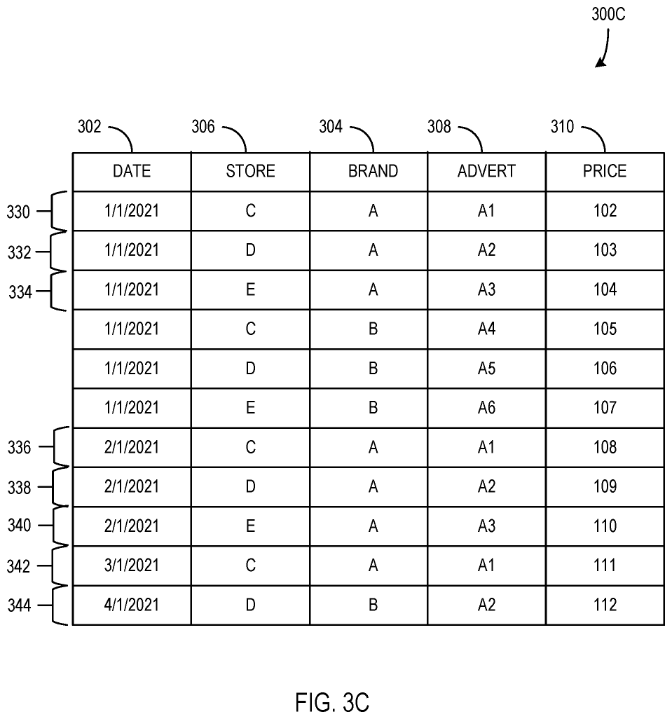

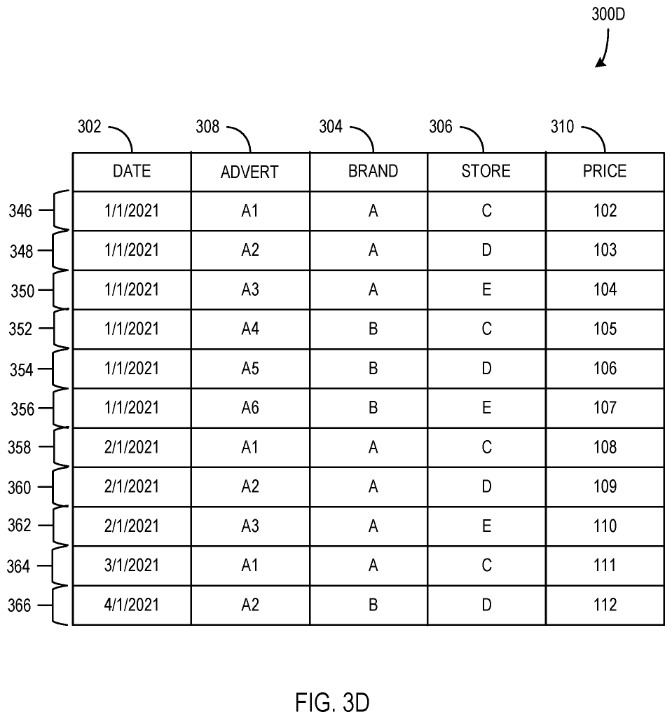

The time series grain generator 104 is configured to generate cardinality estimate values 112 for each category in the candidate category set 108 using a probabilistic cardinality estimator 110. In some examples, the probabilistic cardinality estimator 110 is configured to select a category of the candidate category set 108 and generate a cardinality estimate value 112 associated with the selected category combined with the time index 126 of the data set 102. In such examples, the cardinality estimate value 112 indicates an estimated quantity of entries 124 with unique combinations of a time index value and a selected category value. The use of cardinality with respect to categories is described in greater detail below with respect to FIGS. 3A-D.

In some examples, the probabilistic cardinality estimator 110 is configured to perform an algorithm such as the HLL algorithm. Other types of algorithms are used in other examples without departing from the description.

Further, in some examples, the time series grain generator 104 is configured to generate exact cardinality values for the categories of the candidate category set 108. In such examples, the generator 104 counts the unique combinations of time index values and selected category values to calculate a cardinality value for a selected category. Such calculations are performed using brute force algorithms or other methods of calculating exact cardinality values.

The candidate categories of the candidate category set 108 and the associated cardinality estimate values 112 are used by the time series identifier generator 114 to generate the time series identifier 118. Further, in some examples, a category quantity limit 116 is defined that limits the quantity categories that can be included in the time series identifier 118.

In some examples, the time series identifier generator 114 is configured to select a candidate category from the set 108 with the highest associated cardinality estimate value 112 for use in the time series identifier 118. If that cardinality estimate value 112 is equal to the quantity of data entries 124 in the time series data set 102, then the selected candidate category combined with the time index 126 of the data set 102 is sufficient to form a time series identifier 118 that can be used to eliminate duplicate time index values from the partitioned data sets that will be generated therefrom. Alternatively, if the value 112 of the selected category is not large enough to equal the quantity of data entries 124, the time series identifier generator 114 is configured to select another category to combine with the time index and the first selected category in the time series identifier 118. In such examples, the time series identifier generator 114 is configured to select multiple categories until the combined cardinality estimate values 112 are sufficiently high to equal the quantity of data entries 124 and therefore eliminate the duplicate time index values from partitioned data sets as described herein.

In some examples, the selecting of multiple categories for use in the time series identifier 118 is limited based on a category quantity limit 116. In such an example, after the time series identifier generator 114 selects ten categories for use in the time series identifier 118, the quantity of selected categories meets the defined limit of ten and the time series identifier generation process is complete, even if the combined cardinality estimate values 112 of the selected categories is still insufficient to meet the total quantity of data entries 124 and ensure that no duplicate time index values are present in the partitioned data sets. In other examples, the category quantity limit 116 is defined as a different value without departing from the description.

A pseudocode example of the time series identifier 118 generation process is provided below.

Input: Data (time series data set 102)
Output: grain-idx (time series identifier 118)

| | |
|---|---|
| 1 | grain-idx = 0 |
| 2 | time-col = (time index 126 column) |
| 3 | candidate-list = SelectCandidateCategories (Data) |
| 4 | while duplicate in time-col and len (grain-idx) < 10 |
| 5 | for each candidate in candidate-list: |
| 6 | combine [time-col, candidate] |
| 7 | EstimateCardinality (time-col, candidate) |
| 8 | end |
| 9 | c = SelectCandidateWithHighCardinality ( ) |
| 10 | grain-idx = grain-idx + c |
| 11 | time-col = time-col + c |
| 12 | end |
| 13 | return grain-idx |

In the above example, the input is the time series data set 102, labeled “Data” and the output is the time series identifier 118, labeled “grain-idx”. The grain-idx is initialized to be empty and the candidate of candidates, labeled “candidate-list”, is generated using a function “SelectCandidateCategories”, representing the operations of the candidate category selector 106. A while loop is initiated that is configured to continue looping while duplicates (e.g., entries with duplicate index values) exist for an index identified as “time-col”, which is the time index 126 column combined with the columns in the grain-idx and while the length of grain-idx is below ten categories, which is the category quantity limit 116. In some examples, determining whether duplicates exist for time-col includes determining whether a cardinality estimate of time-col meets or exceeds the quantity of records in the time series data set 102.

On each loop of the while loop, for each candidate in the candidate-list, the time-col and candidate are combined and a cardinality estimate value 112 for the candidate is generated using the function “EstimateCardinality”, representing the operations of the probabilistic cardinality estimator 110. After all the cardinality estimate values 112 are generated, a candidate ‘c’ is selected with the highest value 112 using the function “SelectCandidateWithHighCardinality”, representing some functionality of the time series identifier generator 114 as described herein. In some examples, the SelectCandidateWithHighCardinality function is performed using a greedy algorithm or the like.

After the candidate ‘c’ is selected, it is added to the grain-idx at line 10 and it is added to the time-col at line 10. The function loops back to the start of the while loop, where it is determined whether duplicates remain in the time-col (the time index 126 column and the column(s) of the grain-idx). In some examples, this determination process includes determining whether the cardinality of the current grain-idx is sufficient to eliminate or otherwise prevent duplicate time indexes in data sets that are partitioned based on the current grain-idx. If duplicates are likely to remain, another loop of the functions inside the while loop is performed. If the duplicates have been eliminated or otherwise prevented, the while loop ends and the current grain-idx is returned as output of the process.

In some examples, after a candidate has been added to the grain-idx, it is removed from the candidate-list, such that the remaining candidates are available for selection and inclusion in the grain-idx in subsequent loops of the while loop. Further examples of such a process are described below with respect to FIGS. 3A-D.

Further, the time series grain generator 104 is configured to use the time series identifier 118 to partition the time series data set 102 into time series grain data sets 122 using the time series partitioner 120. In some examples, the time series partitioner 120 is configured to generate a plurality of time series grain data sets 122, wherein each time series grain data set 122 is associated with a unique value of the time series identifier 118. For instance, if the time series identifier 118 includes a category A and a category B and possible values for category A and category B are one and two, then the time series partitioner 120 is configured to generate separate time series grain data sets 122 for data entries 124 where category A is one and category B is one, data entries 124 where category A is two and category B is one, data entries 124 where category A is one and category B is two, and data entries 124 where category A is two and category B is two. Thus, different grain data sets 122 are generated from the time series data set 102 and entries with duplicate time index values are split between the different grain data sets 122, such that each grain data set 122 does not include any entries with duplicate time index values.

In some examples, by preventing entries with duplicate time index values from being present in the time series grain data sets 122, the time series grain generator 104 generates data sets that can be used to train models using machine learning techniques. A ‘grain’ is a subset of training data that can be used to train a model to perform a task associated with a specific type of data. For instance, the grain data set from the example above, where category A is one and category B is one, is a grain that can be used to train a model to classify or make a prediction about future data entries that also have a category A value of one and a category B value of one.

In some examples, a time series data set 102 can become large and adversely impact the effectiveness and/or efficiency of the time series grain generator 104 and/or other methods of determining a time series identifier 118. In such examples, the data set 102 includes entries 124 that have values associated with a time index 126, categories 128, and other values 130, such as continuous values that are relevant to the model training process. For the purposes of discussing the runtime and scale of the time series grain generation process, the other values 130 can be ignored as they are not necessary for generating and/or inferring the time series grain indices from the categories 128.

The data set 102 can become large or otherwise adversely affect the runtime and/or performance of the time series grain generator 104 in various ways, such as: the data set 102 includes many categories 128 that are potential candidate columns to be evaluated (e.g., a “wide” data set 102); the data set 102 includes one or more categorical columns of high cardinality that must be partitioned many times to evaluate overlap in the time series identifier 118 (e.g., a User Identifier category for a large manufacturer); and/or the data set 102 includes one or more series with long time index 126 values (e.g., a time series of high granularity covering a large data range).

For a “wide” data set 102 with many categories 128, the time series grain generator 104 is configured to evaluate each candidate category (e.g., in the loop at line 4 of the above example). The quantity of work to be performed in that loop scales linearly with the number of candidate categories to be evaluated, resulting in runtimes that increase with the number of categories. However, in some of such examples, to preserve a low latency for the operation of the time series grain generator 104, the generator 104 is configured to parallelize the evaluation of each candidate category (there are no inter-candidate dependencies in the example process from lines 4 to 7). This configuration provides near-linear (e.g., ideal) scaling efficiency, regardless of the quantity candidate categories being evaluated, if the generator 104 has access to sufficient computational resources.

Further, when the generator 104 evaluates a candidate category that has a high cardinality, the efficiency of the process could be hampered (e.g., the example process at lines 5 and 6 of the above example). However, in some examples, the data set 102 is partitioned into multiple subsets and each of the multiple subsets is evaluated with respect to the cardinality of the candidate category. Each of the subsets is evaluated in parallel, thus significantly reducing the total time required to evaluate the category and determine the cardinality estimate value 112. Similarly, in some examples, such batch partitioning and parallel processing is used on time series data sets 102 that include a large quantity of entries. Such parallel batch processing configurations of the generator 104 provides a linear increase in speed of performing the process at lines 5 and 6 of the above example. For example, the algorithm selects a candidate partition column X, which has many unique values X1, X2, . . . , Xn. The cardinality of each sub-partition is evaluated based on the values X1, X2, . . . , Xn in parallel.

Additionally, or alternatively, in some examples, the time series grain generator 104 is configured to efficiently process long and/or highly granular time series data sets 102. In such examples, the generator 104 is configured to use batchwise streaming to perform cardinality estimation processes (e.g., generating the cardinality estimate values 112). Cardinality estimation via a set-like structure is fundamentally streaming compatible and the data is loaded batchwise from external storage, evaluated, and discarded, while the set of unique elements identified is updated during the evaluation. Further, the generator 104 partitions the data set 102 into subsets to enable parallelization as described above. For the subsets evaluated, the sets of identified unique elements are merged together to capture the unique elements observed in the overall data set 102. Additionally, or alternatively, the generator 104 uses cardinality estimation (e.g., a HLL process), rather than precise cardinality calculation, to minimize the memory required to generate the cardinality estimate values 112. Because the generator 104 is configured to select categories that minimize duplication of the time index, a precise cardinality value is not required to select the category with the highest cardinality in most cases. All of these features are mutually compatible, allowing them to be layered together in different ways in other examples without departing from the description to optimize the evaluation of a given data set.

Further, it should be understood that, in examples where the time series data set includes a time series index or time series identifier that does not include duplicate values prior to the performance of the described process, the process terminates and the existing time series index is used.

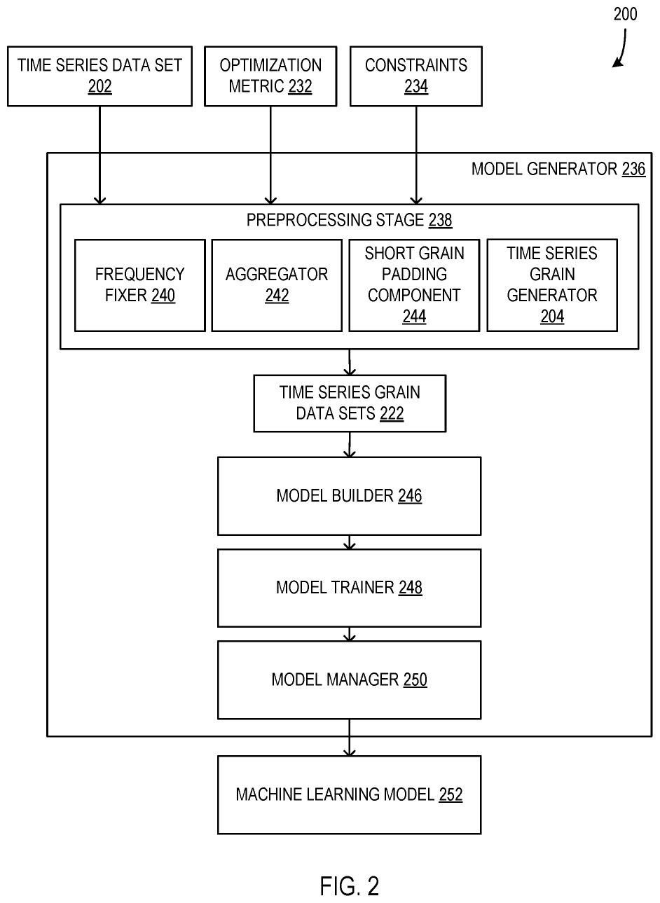

FIG. 2 is a block diagram illustrating a system 200 configured to train a machine learning model 252 based on time series grain data sets 222 generated from a time series grain generator 204. In some examples, the time series grain generator 204 operates as described above with respect to the time series grain generator 104 of FIG. 1.

The system 200 includes a model generator 236 that is configured to obtain or otherwise receive time series data 202. The model generator 236 performs preprocessing on the time series data 202 in a preprocessing stage 238, which includes the time series grain generator 204. The processed data from the preprocessing stage 238 is then used to build a model using a model builder 246, train the built model using a model trainer 248, and then to deploy and/or manage the trained model using a model manager 250. The trained, deployed model 252 is the output of the model generator 236.

Further, in some examples, the model generator 236 is configured to obtain or otherwise receive optimization metrics 232 and/or constraints 234. In such examples, the optimization metrics 232 are input provided to the model generator 236 that indicates metrics of model performance that should be optimized as the model is trained by the model trainer 248. Further, the constraints 234 are input provided to the model generator 236 that indicates limitations or constraints as to how models are trained by the model generator 236. In some examples, optimization metrics include normalized root mean squared errors and/or normalized mean absolute errors and constraints include limitations on use of time and/or resources of the training process, such as a limited time period for the entire training process, limited time periods for each iteration of training, and/or other limitations that result in stopping the training process early to save time and/or resources.

In some examples, the preprocessing stage 238 includes a frequency fixer 240, an aggregator 242, and/or a short grain padding component 244 in addition to the time series grain generator 204. In such examples, the frequency fixer 240 is configured to analyze grains of the time series data set 202 to identify data entries or points of the grains that include data that does not comply with a defined frequency. When such data entries are detected by the frequency fixer 240, those data entries are removed from the analyzed grains of data entries. The result is training grain data sets that include data entries that comply with a defined data frequency, such that training models using the training grain data sets is more efficient and/or effective.

Further, in examples where the preprocessing stage includes an aggregator 242, the aggregator 242 is configured to analyze the time series data set 202 and to use clustering-based methods to reduce the data set 202 into fewer rows or entries.

Additionally, or alternatively, in examples where the preprocessing stage 238 includes a short grain padding component 244, the short grain padding component 244 is configured to analyze the time series data set 202 and to identify short training grain data sets therein (e.g., training grain data sets with a quantity of entries that fails to meet a defined threshold). The short grain padding component 244 is configured to pad the short training grain data sets with additional data to fill them out.

In some examples, the model builder 246 of the model generator 236 is configured to build and/or initialize machine learning models. Further, the model builder 246 is configured to enable users of the system 200 to provide input to the model builder 246 to determine or otherwise influence how a model is built and/or configured.

In some examples, the model trainer 248 trains the built models based on the time series grain data sets 222 generated during the preprocessing stage 238. Such training processes include machine learning operations that train models for classification, prediction, or the like. In some examples, the model trainer 248 uses a variety of different machine learning model training techniques without departing from this description. Further, in some examples, the model trainer 248 is configured to tune models after they have been initially trained to improve the performance of those models. Additionally, trained and/or tuned models are tested and/or evaluated by the model trainer 248 to verify that they perform sufficiently well prior to the models being considered fully trained.

In some examples, the model manager 250 is configured to manage trained models 252 and to deploy those models 252 and/or otherwise enable those models 252 to be deployed. Additionally, or alternatively, the model manager 250 enables users of the system 200 to access the trained models 252 and/or request that the trained models 252 be deployed to systems that are outside of the system 200.

Further, in some examples, the model generator 236 includes a user interface that provides information about the processes performed by the model generator. In some examples, when a user provides a time series data set 202 without indicating time series identifier categories to be used to partition the time series data set 202, the model generator uses the time series grain generator 204 to determine a time series identifier of the data set and displays the time series identifier to the user. Additionally, or alternatively, the model generator 236 prompts the user to accept or reject the displayed time series identifier, such that the generator 236 operates as a recommender of the time series identifier. In some such examples, the generator 236 enables the user to select other categories to include in the time series identifier or to otherwise alter the time series identifier before the time series grain data sets 222 are generated and used to generate trained models as described herein.

Further, in some examples, the time series grain generator 204 is used by the model generator 236 to check provided time series identifier categories to confirm that they are sufficient to avoid duplicate time index values in the time series grain data sets 222. In such examples, the provided time series identifier categories are analyzed to generate cardinality estimate values for each category as described herein. The generated cardinality estimate values are used to determine whether duplicate time index values will be present in data subsets that are based on the time series identifier categories. If the check fails, the model generator 236 is configured to notify the user and/or request that the user alter the provided time series identifier categories. In some of such examples, a recommendation of time series identifier categories is provided to the user as described above.

FIGS. 3A-D are diagrams illustrating a time series data set and selecting candidate categories of the data set based on the cardinality thereof. The illustrated data set includes a time index called date 302 which includes dates for each entry (illustrated as rows of the table). Further, the illustrated data set includes candidate categories of brand 304, store 306, and advert 308. Finally, there is a data field called price 310. Price 310 is not a candidate category because the data set will be used to train models that predict price values based on other data provided, such that the price values cannot be used to divide the data set into grains.

The diagram 300A further shows the sets of rows that include duplicate date values. The set of rows 312 have date value 1/1/2021 (month/day/year), the set of rows 314 have date value 2/1/2021, the row 316 has date value 3/1/2021, and the row 318 has date value 4/1/2021. Because there are duplicate date values, the full data set cannot be used to train models as described herein. One or more additional categories must be identified that can be used as a time series identifier for partitioning the data set.

It should be understood that, in other examples, such a data set includes a column that is explicitly used for a time series identifier. Alternatively, or additionally, the data set is provided with one or more categories specified for use as a time series identifier. In such examples, the process described herein is unnecessary and the provided time series identifier is used to partition the data as described herein.

The diagram 300B shows the cardinality of the brand 304 category when combined with the date 302 values. The cardinality of brand 304 is five, in that there are five unique combinations of date 302 values and brand 304 values. The set of rows 320 have date value of 1/1/2021 and brand value of A, the set of rows 322 have date value of 1/1/2021 and brand value of B, the set of rows 324 have date value of 2/1/2021 and brand value of A, the row 326 has a date value of 3/1/2021 and a brand value of A, and the row 328 has a date value of 4/1/2021 and a brand value of B.

Because duplicate date values remain in some of the sets of rows (e.g., the cardinality of five is less than the total quantity of entries, which is eleven), the brand 304 category is not sufficient for use as the time series identifier.

The diagram 300C shows the cardinality of the store 306 category when combined with the date 302 values. The cardinality of the store 306 category is eight, because there are eight unique combinations of date 302 values and store 306 values. The row 330 has a date value of 1/1/2021 and a store value of C, the row 332 has a date value of 1/1/2021 and a store value of D, and the row 334 has a date value of 1/1/2021 and a store value of C. Each of the rows 330, 332, and 334 has a duplicate row in the immediate next three rows with respect to date and store values. Further, the row 336 has a date value of 2/1/2021 and a store value of C, the row 338 has a date value of 2/1/2021 and a store value of D, the row 340 has a date value of 2/1/2021 and a store value of E, the row 342 has a date value of 3/1/2021 and a store value of C, and the row 344 has a date value of 4/1/2021 and a store value of D. These five rows do not have duplicate rows in the data set.

Because duplicate date values remain in some of the sets of rows (e.g., the cardinality of eight is less than the total quantity of entries, which is eleven), the store 306 category is not sufficient for use as the time series identifier.

The diagram 300D shows the cardinality of the advert 308 category when combined with the date 302 values. The cardinality of the advert 308 category is eleven, in that there are eleven unique combinations of date 302 values and advert 308 values. The row 346 has a date value of 1/1/2021 and an advert value of A1, the row 348 has a date value of 1/1/2021 and an advert value of A2, the row 350 has a date value of 1/1/2021 and an advert value of A3, the row 352 has a date value of 1/1/2021 and an advert value of A4, the row 354 has a date value of 1/1/2021 and an advert value of A5, the row 356 has a date value of 1/1/2021 and an advert value of A6, the row 358 has a date value of 2/1/2021 and an advert value of A1, the row 360 has a date value of 2/1/2021 and an advert value of A2, the row 362 has a date value of 2/1/2021 and an advert value of A3, the row 364 has a date value of 3/1/2021 and an advert value of A1, and the row 366 has a date value of 4/1/2021 and an advert value of A2.

Because duplicate date values are not present in some of the sets of rows (e.g., the cardinality of eleven is equal to the total quantity of entries), the advert 308 category is suitable for use as the time series identifier. In some examples, the advert 308 category is selected for use as the time series identifier 118 by a time series identifier generator 114 as described herein after generating the cardinality estimate values 112 for each of the candidate categories.

It should be understood that the example data set of FIGS. 3A-D is small and determining exact cardinality of the categories of the data set is relatively simple. However, in other examples, the data sets being analyzed are very large and complex, with millions of rows or entries and hundreds of possible categories. In such examples, the generation of cardinality estimate values using probabilistic cardinality estimation techniques provides substantial advantages with respect to performance and resource consumption of the process when compared to the calculation of exact cardinalities of categories.

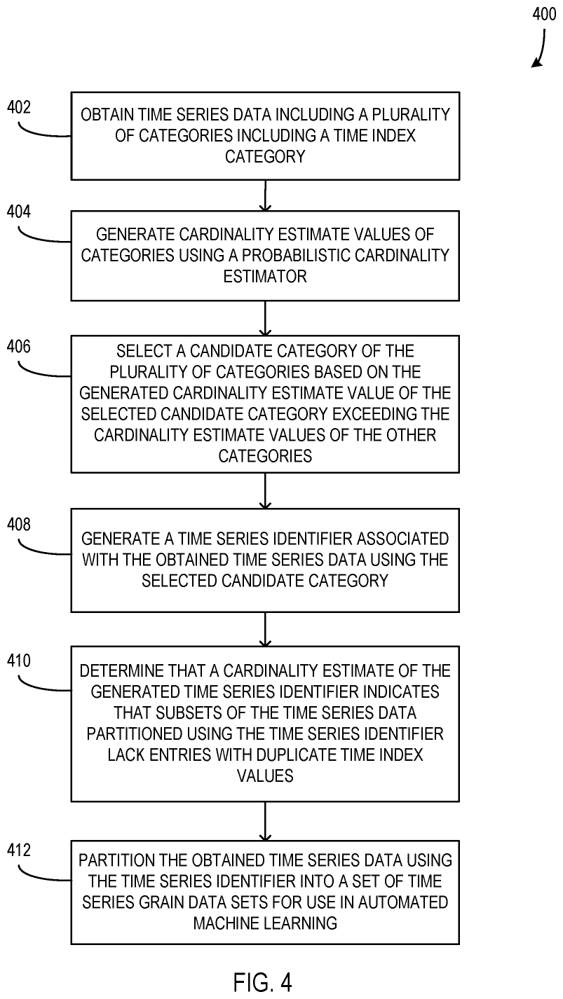

FIG. 4 is a flowchart illustrating a method 400 for partitioning time series data into a set of time series grain data sets that lack entries with duplicate time index values. In some examples, the method 400 is executed or otherwise performed by a system such as system 100 of FIG. 1. At 402, time series data is obtained. The time series data includes a plurality of categories, one of which is a time index category. Further, the time series data includes entries that have duplicate time index values (e.g., at least two entries that have the same time index value in the time index category). In some examples, obtaining the time series data includes detecting or otherwise determining that entries with duplicate time index values are present. In other examples, if no entries with duplicate time index values are present in the time series data, the method 400 is ended early, as the time series data can already be used for training models as described herein.

At 404, cardinality estimate values are generated for the categories of the time series data using a probabilistic cardinality estimator. In some examples, the cardinality estimate values are generated using a HLL algorithm or other similar algorithm. Further, in some examples, the generation of the cardinality estimate values of multiple categories are generated in parallel (e.g., the processes of generating multiple cardinality estimate values are performed simultaneously). Additionally, or alternatively, the process of generating a cardinality estimate value is divided into multiple batch sets of the time series data, such that multiple subset cardinality estimate values are generated in parallel and the multiple subset cardinality estimate values are combined to form the cardinality estimate value of the category.

Further, in some examples, each cardinality estimate value is generated with respect to the time series category in combination with associated category. For instance, as described above with respect to FIGS. 3A-D, a cardinality estimate value of a brand category is an estimate of the quantity of unique combinations of a time series value and a brand value that are present in entries of the time series data.

At 406, a candidate category is selected based on the cardinality estimate value of the selected candidate category exceeding the cardinality estimate values of the other categories. In some examples, the candidate category is selected using a greedy algorithm or the like.

At 408, a time series identifier associated with the obtained time series data is generated using the selected candidate category. In some examples, the generation of the time series identifier further includes using one or more other candidate categories, wherein a cardinality estimate value of the time series identifier is based on a combination of the cardinality estimate values of the candidate category and any other categories that are used to generate the time series identifier.

At 410, it is determined that a cardinality estimate of the generated time series identifier indicates that subsets of the time series data partitioned using the time series identifier lack entries with duplicate time index values. In some examples, this determination includes determining that the cardinality estimate of the generated time series identifier equals or exceeds the quantity of records in the time series data, as described herein.

At 412, the obtained time series data are partitioned into a set of time series grain data sets using the time series identifier (e.g., based on the cardinality estimate value of the time series identifier indicating that subsets of the time series data partitioned based on the time series identifier lack entries with duplicate time index values). In some examples, the cardinality estimate value of the candidate category is compared to the quantity of entries in the time series data and, when the cardinality estimate value is equal to the quantity of entries, the obtained time series data is partitioned into the time series grain data sets as described herein.

Further, in some examples, partitioning the time series data into time series grain data sets based on the time series identifier includes generating a time series grain data set for each unique value of the time series identifier and partitioning the data entries into those time series grain data sets based on the associated category values of the data entries (e.g., for a brand category, each entry associated with brand A is partitioned into one time series grain data set and each entry associated with brand B is partitioned into another time series grain data set).

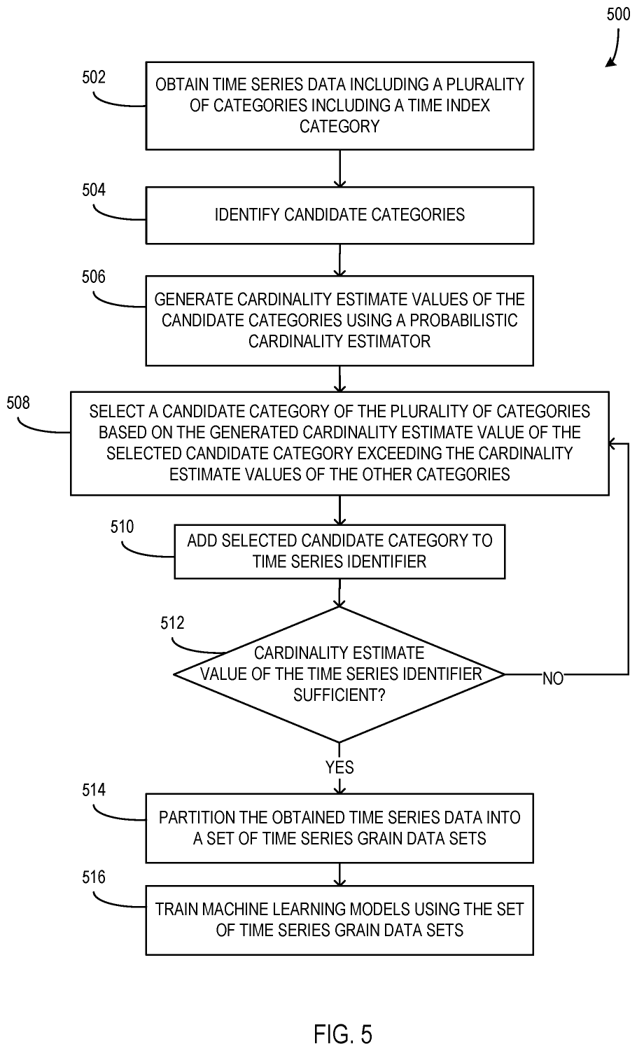

FIG. 5 is a flowchart illustrating a method for partitioning time series data into a set of time series grain data sets based on a time series identifier derived from candidate categories. In some examples, the method 500 is executed or otherwise performed by a system such as system 100 of FIG. 1. At 502, time series data is obtained. The time series data includes a plurality of categories, one of which is a time index category. Further, the time series data includes entries that have duplicate time index values (e.g., at least two entries that have the same time index value in the time index category).

At 504, candidate categories are identified from the plurality of categories. In some examples, identifying candidate categories includes identifying categories that, for each entry in the time series data, a value is included (e.g., candidate categories must be complete throughout the data set).

At 506, cardinality estimate values are generated for the candidate categories using a probabilistic cardinality estimator. Further, in some examples, the cardinality estimate values are generated in substantially the same manner as described above with respect to 404 of FIG. 4.

At 508, a candidate category is selected based on the cardinality estimate value exceeding the cardinality estimate values of the other categories and, at 510, the selected candidate category is added to or otherwise included in a time series identifier. In some examples, the time series identifier includes multiple categories from the time series data, such that the cardinality estimate values of each of the multiple categories included are combined into a single cardinality estimate value of the time series identifier. For example, the cardinality estimate value of the time series identifier is an estimate of the quantity of unique combinations of time index value and values of each of the multiple categories that are present in the time series data.

At 512, if the cardinality estimate value of the time series identifier is sufficient to eliminate entries with duplicate time series values from resulting time series grain data sets, the process proceeds to 514. Alternatively, if the cardinality estimate value of the time series identifier is insufficient, the process returns to 508 to select another candidate category for inclusion in the time series identifier. In examples where the process returns to 508, the category with the next highest cardinality estimate value is selected as a candidate category to be included in the time series identifier at 510.

At 514, the time series data is partitioned into time series grain data sets based on the time series identifier. In some examples, the partitioning is performed in substantially the same manner as described above with respect to 408 of FIG. 4. In examples where multiple categories are included in the time series identifier, each time series grain data set is associated with a unique combination of values of the multiple categories (e.g., entries associated with a brand A and a store A are partitioned into a first time series grain data set, entries associated with a brand A and a store B are partitioned into a second time series grain data set, and entries associated with a brand B and a store A are partitioned into a third time series grain data set).

At 516, the time series grain data sets are used to train machine learning models. In some examples, each time series grain data set is used to train a separate model using machine learning techniques. Alternatively, or additionally, multiple time series grain data sets are used to train a single model in separate rounds of training. In some such examples, the models are trained to perform classification operations, regression operations, and/or forecasting or prediction operations. In other examples, other types of models are trained using the time series grain data sets without departing from the description.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device. In some examples, partitioning time series data to eliminate the presence of data entries with duplicate time index values in the resulting data subsets as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

### Additional Examples

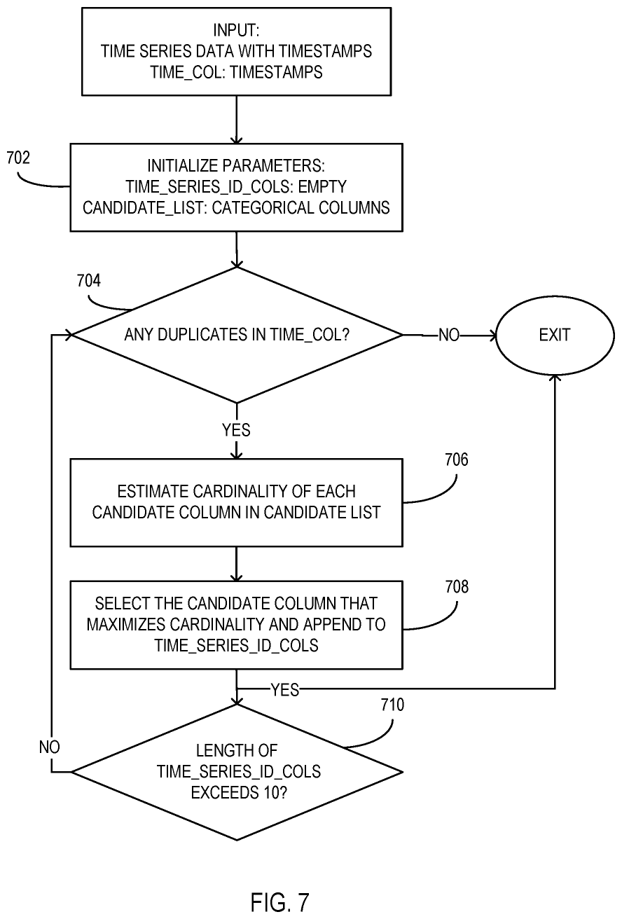

FIG. 7 is a flowchart illustration operation of an example implementation of an automatic time series identifier detection system. In this example, the input is time indexed data points (e.g., a time series data set 102) and the value time_col is the time index (e.g., time indexes 126 of data entries 124) that can include duplicate timestamps output by the short grain padding component 244. Output is the optimal time series identifier columns that allow identifying all unique time series in the dataset in the form of the time_series_id_cols structure.

At 702, the values of time_series_id_cols and candidate_list are initialized. The time_series_id_cols is set to empty and the candidate_list is initialized with the categorical columns of the time series data set. The data is processed until there are no duplicates in time_col in combination with the candidate columns identified in the time_series_id_cols. Operation 704 checks if there is any duplication in time_col with respect to the categories of time_series_id_cols as described herein. If not, the algorithm exits.

At 706, the number of unique groups or the cardinality estimation is calculated for each candidate column in the candidate list. In some examples, a probabilistic cardinality estimator 110 is used to determine cardinality estimate values 112 for each of the candidate columns in the candidate list as described herein.

At 708, the candidate that maximizes the cardinality is picked and appended to existing time_series_id_cols list. In some examples, the time_series_id_cols is a time series identifier 118 that is generated and/or updated by a time series identifier generator 114 as described herein.

To return in a reasonable time, the length of the time series identifier columns is limited to 10 in this example. This limit is checked at 710. If length of time series identifiers is less than 10, the algorithm continues at 704. Otherwise, it terminates.

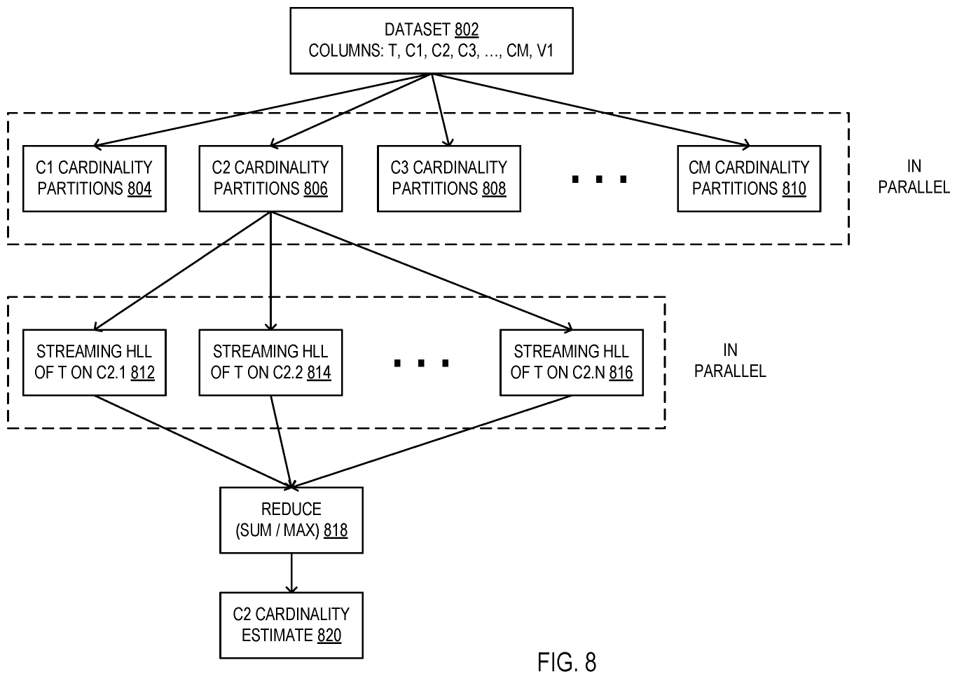

FIG. 8 is a diagram illustrating an example implementation of parallel cardinality processing. As illustrated, the dataset 802 includes a time column T, categorical columns C1, C2, C3, . . . , CM, and a non-categorical data column V1. for each categorical column C1-CM, a cardinality estimate is generated as described herein. The generation of cardinality estimates for each categorical column are generated in parallel as illustrated in this example, wherein each generation process includes dividing the data set 802 into sub-partitions 804, 806, 808, and 810 for each categorical column.

Further, within each cardinality estimate generation process, the process of performing a HLL algorithm on each sub-partition of the data set is done in parallel for a particular categorical column, such as C2. For instance, as illustrated, the performance of HLL processes on a first C2 sub-partition 812, a second C2 sub-partition, through to an Nth C2 sub-partition 816 are performed in parallel. Upon completion of these parallel processes, the results are reduced or otherwise combined at 818 into a cardinality estimate 820 for the categorical column C2. It should be understood that the application of HLL to the sub-partitions associated with other categorical column processes (e.g., C1, C3, CM) are also performed in parallel.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; and at least one memory comprising computer program code, the at least one memory and the computer program code configured to, with the at least one processor, cause the at least one processor to: obtain time series data including a plurality of categories, wherein the plurality of categories includes a time index category, wherein the obtained time series data includes entries with duplicate time index values; generate cardinality estimate values for categories of the plurality of categories using a probabilistic cardinality estimator; select a candidate category of the plurality of categories based on the generated cardinality estimate value of the selected candidate category exceeding the cardinality estimate values of the other categories of the plurality of categories; generate a time series identifier associated with the obtained time series data using the selected candidate category; determine that a cardinality estimate of the generated time series identifier indicates that subsets of the time series data partitioned using the time series identifier lack entries with duplicate time index values; and partition the obtained time series data using the time series identifier into a set of time series grain data sets for use in automated machine learning.

An example computerized method comprises: obtaining, by a processor, time series data including a plurality of categories, wherein the plurality of categories includes a time index category, wherein the obtained time series data includes entries with duplicate time index values; generating, by the processor, cardinality estimate values for categories of the plurality of categories using a probabilistic cardinality estimator; selecting, by the processor, a candidate category of the plurality of categories based on the generated cardinality estimate value of the selected candidate category exceeding the cardinality estimate values of the other categories of the plurality of categories; generating, by the processor, a time series identifier associated with the obtained time series data using the selected candidate category; and based on a cardinality estimate value of the generated time series identifier indicating that subsets of the time series data partitioned based on the time series identifier lack entries with duplicate time index values, partitioning, by the processor, the obtained time series data based on the time series identifier into a set of time series grain data sets for use in automated machine learning.

One or more computer storage media have computer-executable instructions that, upon execution by a processor, cause the processor to at least: obtain time series data including a plurality of categories, wherein the plurality of categories includes a time index category, wherein the obtained time series data includes entries with duplicate time index values; generate cardinality estimate values for categories of the plurality of categories using a probabilistic cardinality estimator; select a candidate category of the plurality of categories based on the generated cardinality estimate value of the selected candidate category exceeding the cardinality estimate values of the other categories of the plurality of categories; generate a time series identifier associated with the obtained time series data using the selected candidate category; and based on a cardinality estimate value of the generated time series identifier indicating that subsets of the time series data partitioned based on the time series identifier lack entries with duplicate time index values, partition the obtained time series data based on the time series identifier into a set of time series grain data sets for use in automated machine learning.

Alternatively, or in addition to the other examples described herein, examples include any combination of the following:
further comprising: training a machine learning model based on at least one of the time series grain data sets using machine learning techniques.
further comprising: identifying a set of candidate categories of the plurality of categories of the time series data, wherein each entry of the time series data includes a value for each candidate category of the set of identified candidate categories; and wherein cardinality estimate values are generated for each category of the identified set of candidate categories using the probabilistic cardinality estimator.
further comprising: determining that a cardinality estimate value of the candidate category indicates that subsets of the time series data partitioned using the candidate category include entries with duplicate time index values; selecting a second candidate category of the plurality of categories based on the generated cardinality estimate value of the selected second candidate category; and wherein generating the time series identifier further includes using the selected second candidate category.
wherein generating cardinality estimate values for categories of the plurality of categories using the probabilistic cardinality estimator further includes: selecting a category of the plurality of categories; dividing the time series data into a plurality of data subsets; generating subset cardinality estimate values of the selected category combined with the time index category for each data subset of the plurality of data subsets; and combining the generated subset cardinality estimate values into a cardinality estimate value of the selected category.
wherein at least two of the subset cardinality estimate values are generated in parallel with each other.
wherein at least two cardinality estimate values are generated in parallel with each other.

Any range or device value given herein may be extended or altered without losing the effect sought, as will be apparent to the skilled person.

Examples may have been described with reference to data monitored and/or collected from the users. In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining, by a processor, time series data including a plurality of categories, wherein the plurality of categories includes a time index category, wherein the obtained time series data includes entries with duplicate time index values; exemplary means for generating, by the processor, cardinality estimate values for categories of the plurality of categories using a probabilistic cardinality estimator; exemplary means for selecting, by the processor, a candidate category of the plurality of categories based on the generated cardinality estimate value of the selected candidate category exceeding the cardinality estimate values of the other categories of the plurality of categories; exemplary means for generating, by the processor, a time series identifier associated with the obtained time series data using the selected candidate category; and based on a cardinality estimate value of the generated time series identifier indicating that subsets of the time series data partitioned based on the time series identifier lack entries with duplicate time index values, exemplary means for partitioning, by the processor, the obtained time series data based on the time series identifier into a set of time series grain data sets for use in automated machine learning.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor; and
at least one memory comprising computer program code, the at least one memory and the computer program code configured to, with the at least one processor, cause the at least one processor to:
obtain time series data including a plurality of categories, wherein the plurality of categories includes a time index category, wherein the obtained time series data includes entries with duplicate time index values;
generate cardinality estimate values for categories of the plurality of categories using a probabilistic cardinality estimator;
select a candidate category of the plurality of categories based on the generated cardinality estimate value of the selected candidate category exceeding the cardinality estimate values of the other categories of the plurality of categories;
generate a time series identifier associated with the obtained time series data using the selected candidate category;
determine that a cardinality estimate of the generated time series identifier indicates that subsets of the time series data partitioned using the time series identifier lack entries with duplicate time index values; and
partition the obtained time series data using the time series identifier into a set of time series grain data sets for use in automated machine learning.

2. The system of claim 1, wherein the at least one memory and the computer program code is configured to, with the at least one processor, cause the at least one processor to:
train a machine learning model based on at least one of the time series grain data sets using machine learning techniques.

3. The system of claim 1, wherein the at least one memory and the computer program code is configured to, with the at least one processor, cause the at least one processor to:
identify a set of candidate categories of the plurality of categories of the time series data, wherein each entry of the time series data includes a value for each candidate category of the set of identified candidate categories; and
wherein cardinality estimate values are generated for each category of the identified set of candidate categories using the probabilistic cardinality estimator.

4. The system of claim 1, wherein the at least one memory and the computer program code is configured to, with the at least one processor, cause the at least one processor to:
determine that a cardinality estimate value of the candidate category indicates that subsets of the time series data partitioned using the candidate category include entries with duplicate time index values;
select a second candidate category of the plurality of categories based on the generated cardinality estimate value of the selected second candidate category; and
wherein generating the time series identifier further includes using the selected second candidate category.

5. The system of claim 1, wherein generating the cardinality estimate values for categories of the plurality of categories using the probabilistic cardinality estimator further includes:
selecting a category of the plurality of categories;
dividing the time series data into a plurality of data subsets;
generating subset cardinality estimate values of the selected category combined with the time index category for each data subset of the plurality of data subsets; and
combining the generated subset cardinality estimate values into a cardinality estimate value of the selected category.

6. The system of claim 5, wherein at least two of the subset cardinality estimate values are generated in parallel with each other.

7. The system of claim 1, wherein at least two cardinality estimate values are generated in parallel with each other.

8. A computerized method comprising:
obtaining, by a processor, time series data including a plurality of categories, wherein the plurality of categories includes a time index category, wherein the obtained time series data includes entries with duplicate time index values;
generating, by the processor, cardinality estimate values for categories of the plurality of categories using a probabilistic cardinality estimator;
selecting, by the processor, a candidate category of the plurality of categories based on the generated cardinality estimate value of the selected candidate category exceeding the cardinality estimate values of the other categories of the plurality of categories;
generating, by the processor, a time series identifier associated with the obtained time series data using the selected candidate category;
determining, by the processor, that a cardinality estimate of the generated time series identifier indicates that subsets of the time series data partitioned using the time series identifier lack entries with duplicate time index values; and
partitioning, by the processor, the obtained time series data using the time series identifier into a set of time series grain data sets for use in automated machine learning.

9. The computerized method of claim 8, further comprising:
training a machine learning model based on at least one of the time series grain data sets using machine learning techniques.

10. The computerized method of claim 8, further comprising:
identifying a set of candidate categories of the plurality of categories of the time series data, wherein each entry of the time series data includes a value for each candidate category of the set of identified candidate categories; and
wherein cardinality estimate values are generated for each category of the identified set of candidate categories using the probabilistic cardinality estimator.

11. The computerized method of claim 8, further comprising:
determining that a cardinality estimate value of the candidate category indicates that subsets of the time series data partitioned using the candidate category include entries with duplicate time index values;
selecting a second candidate category of the plurality of categories based on the generated cardinality estimate value of the selected second candidate category; and
wherein generating the time series identifier further includes using the selected second candidate category.

12. The computerized method of claim 8, wherein generating the cardinality estimate values for categories of the plurality of categories using the probabilistic cardinality estimator further includes:
selecting a category of the plurality of categories;
dividing the time series data into a plurality of data subsets;
generating subset cardinality estimate values of the selected category combined with the time index category for each data subset of the plurality of data subsets; and
combining the generated subset cardinality estimate values into a cardinality estimate value of the selected category.

13. The computerized method of claim 12, wherein at least two of the subset cardinality estimate values are generated in parallel with each other.

14. The computerized method of claim 8, wherein at least two cardinality estimate values are generated in parallel with each other.

15. One or more computer storage media having computer-executable instructions that, upon execution by a processor, cause the processor to at least:
obtain time series data including a plurality of categories, wherein the plurality of categories includes a time index category, wherein the obtained time series data includes entries with duplicate time index values;
generate cardinality estimate values for categories of the plurality of categories using a probabilistic cardinality estimator;
select a candidate category of the plurality of categories based on the generated cardinality estimate value of the selected candidate category exceeding the cardinality estimate values of the other categories of the plurality of categories;
generate a time series identifier associated with the obtained time series data using the selected candidate category;
determine that a cardinality estimate of the generated time series identifier indicates that subsets of the time series data partitioned using the time series identifier lack entries with duplicate time index values; and
partition the obtained time series data using the time series identifier into a set of time series grain data sets for use in automated machine learning.

16. The one or more computer storage media of claim 15, wherein the computer-executable instructions, upon execution by the processor, further cause the processor to at least:
train a machine learning model based on at least one of the time series grain data sets using machine learning techniques.

17. The one or more computer storage media of claim 15, wherein the computer-executable instructions, upon execution by the processor, further cause the processor to at least:
identify a set of candidate categories of the plurality of categories of the time series data, wherein each entry of the time series data includes a value for each candidate category of the set of identified candidate categories; and
wherein cardinality estimate values are generated for each category of the identified set of candidate categories using the probabilistic cardinality estimator.

18. The one or more computer storage media of claim 15, wherein the computer-executable instructions, upon execution by the processor, further cause the processor to at least:
determine that a cardinality estimate value of the candidate category indicates that subsets of the time series data partitioned using the candidate category include entries with duplicate time index values;
select a second candidate category of the plurality of categories based on the generated cardinality estimate value of the selected second candidate category; and
wherein generating the time series identifier further includes using the selected second candidate category.

19. The one or more computer storage media of claim 15, wherein generating the cardinality estimate values for categories of the plurality of categories using the probabilistic cardinality estimator further includes:
selecting a category of the plurality of categories;
dividing the time series data into a plurality of data subsets;
generating subset cardinality estimate values of the selected category combined with the time index category for each data subset of the plurality of data subsets; and
combining the generated subset cardinality estimate values into a cardinality estimate value of the selected category.

20. The one or more computer storage media of claim 19, wherein at least two of the subset cardinality estimate values are generated in parallel with each other.
